(19) United States
(12) Patent Application Publication
(10) Pub. No.: US 2022/0196525 A1
(43) Pub. Date: Jun. 23, 2022

(54) METHOD AND APPARATUS FOR MAINTAINING CONSTANCY OF FORCE IN CONTACT BETWEEN A TEST PROBE AND TEST OBJECT, WHICH ARE IN A STATE OF RELATIVE MOTION

(71) Applicants: Vishal Khosla, San Jose, CA (US); Nick Doe, San Jose, CA (US); Ming Chan, San Jose, CA (US); Michael Vinogradov-Nurenberg, San Jose, CA (US); Jun Xiao, San Jose, CA (US); Gautam Char, San Jose, CA (US)

(72) Inventors: Vishal Khosla, San Jose, CA (US); Nick Doe, San Jose, CA (US); Ming Chan, San Jose, CA (US); Michael Vinogradov-Nurenberg, San Jose, CA (US); Jun Xiao, San Jose, CA (US); Gautam Char, San Jose, CA (US)

(21) Appl. No.: 17/127,116

(22) Filed: Dec. 18, 2020

(51) Int. Cl. G01N 3/04; G01N 3/56

(52) U.S. Cl. CPC G01N 3/04; G01N 3/56

(57) ABSTRACT

Proposed are a method and apparatus for maintaining constancy of force in contact between a test probe and test object, which are in a state of relative motion, e.g., in a material testing machine. This is achieved by providing the material testing machine with a leveling stage that includes an adjustable leveling mechanism for eliminating deviations of the support surface of the test sample table from flatness and parallelism to a reference plane that passes through the point of contact of the probe with the object perpendicular to the test probe. The mechanism includes springing elements and thrust elements that pass through the carrier member and rest against the springing elements for adjusting thrust forces applied to the springing elements for adjusting a position of the sample supporting surface relative to a virtual reference plane, which passes through the contact point perpendicular to the longitudinal axis of the probe.

### FIELD OF THE INVENTION

The invention relates to a method and apparatus for maintaining constancy of force in contact between a test probe and test object, which are in a state of relative motion. More specifically, the invention relates to the field of material testing, e.g., to a method and apparatus for wear testing, scratch testing, etc., in which a test probe and a test object are in a state of relative motion. In such a test, either a test sample moves relative to a stationary probe in contact with the latter, or vice versa, the test sample is stationary and a probe moves relative to the sample.

### BACKGROUND OF THE INVENTION

The invention relates to the field of tribology, e.g., to a method and apparatus for wear testing, friction testing, scratch testing, etc., in which a test probe and test object are in a state of relative motion. In this relative motion, either a test sample moves relative to a stationary probe in contact with the latter, or vice versa, the test sample is stationary and a probe moves relative to the sample.

In a typical material tester, such as, e.g., a tribometer that is intended for testing a friction force or wear resistant properties of a sample material or a coating on the surface of a substrate (see, e.g., U.S. Pat. No. 10,132,733B2 issued on Nov. 20, 2018 to Vinogradov-Nurenberg, et al.), a tester contains a frame that supports a carriage moveable in a vertical direction, a force sensor assembly attached to the carriage, and a positioning stage with a slide, a platform, and a sample stages on the platform for executing linear or rotary motions of the lower sample relative to the upper sample or a test probe in various directions and planes.

In another example of a material tester, which is described in U.S. Pat. No. 10,024,776 issued on Jul. 17, 2018 to Vishal Khosla, et al., an apparatus for in-line testing and surface analysis contains a base that supports stages that provide movements of the sample stage with a sample in two mutually perpendicular directions and rotation of the sample in a horizontal plane as well as a motion in a vertical direction relative a probe rigidly secured on a frame of the tester.

However, the coating technique has developed, and new coating materials have appeared that made it possible to reduce the thickness of coatings, for example, on different substrates or on the surfaces of flat material samples, to values of the order of nanometers. Therefore, the requirements to devices for measuring the properties of coatings, in particular, for their resistance to scratching and wear, have become more stringent, especially with respect to the accuracy of measurements.

This is because even a slightest deviation of the sample table surface (that during a test supports a thin flat object the coating of which is a subject of test) from flatness, or from parallelism to the plane that passes through the point of the probe with the object perpendicular to the probe will lead to inaccuracy of the test measurements.

Heretofore, the problem described above has not been taken into consideration in tribology measurement or testing devices, and the inventors herein are not aware of the existence of such methods and/or devices.

Devices for maintaining a permanent contact force between a contact tip and an object are known in the art (see, e.g., U.S. Pat. No. 8,427,186B2 issued to Andrew McFarland on Apr. 23, 2013). This patent describes a microelectronic probe element that includes a base, a tip, and a spring assembly coupled between the tip and the base. The spring assembly can include a first spring and a second spring, wherein the first spring has a negative stiffness over a predefined displacement range and the second spring has a positive stiffness over the predefined displacement range. The first spring and second spring can be coupled so that the negative stiffness and positive stiffness substantially cancel to produce a net stiffness of the tip relative to the base over the predefined displacement range. The first spring can have a non-linear spring characteristic. The second spring can have a spring characteristic, which includes a positive stiffness over the predefined displacement range. The second spring can have a linear or non-linear spring characteristic. The first spring and the second spring can be coupled together (e.g., in parallel) so that the negative stiffness of the first spring substantially cancels the positive stiffness of the second spring to produce a net spring characteristic of the probe tip relative to the base having substantially zero stiffness. Accordingly, over the predefined displacement range, the probe can provide a substantially constant contact force. However, a device of U.S. Pat. No. 8,427,186B relates to a stationary situation wherein a motion of the probe relative to the base is absent.

Nevertheless, a device capable of adjusting a fine contact force of the probe to the object to be measured is known in the art and is described in U.S. Pat. No. 8,225,519B2 issued to Yonpyo Hon, et al. issued on Jul. 24, 2012. This device performs measurement with displacement of a probe, while a contact member attached to the probe is in contact with an object to be measured. Data on the relationship of a contact force of the probe to the object to be measured with an angle between the central axis of the probe and the direction of gravity, the amount of displacement of the probe, and a fluid pressure for applying a pushing-out or pulling-in force to the probe is stored in advance and, on the basis of this data, the fluid pressure or the amount of displacement of the probe is controlled to automatically and precisely adjust a fine contact force of the probe to the object to be measured. However, the device of the aforementioned patent and a principle of its structure and operation are inapplicable to a method and apparatus for maintaining constancy of contact force in a universal material tester, e.g., a scratch test apparatus.

### SUMMARY OF THE INVENTION

The invention relates to a method and apparatus for maintaining constancy of force in contact between a test probe and test object, which are in a state of relative motion, e.g., in a material testing machine. This is achieved by providing the material-testing machine with a leveling stage that includes an adjustable leveling mechanism for eliminating deviations of the support surface of the test sample table from flatness and parallelism to a reference plane that passes through the point of contact of the probe with the object perpendicular to the test probe. The leveling mechanism includes springing elements and thrust elements that pass through the carrier member and rest against the springing elements for adjusting thrust forces applied to the springing elements for adjusting a position of the sample supporting surface relative to a virtual reference plane, which passes through the contact point perpendicular to the longitudinal axis of the probe.

### BRIEF DESCRIPTION OF THE DRAWINGS

FIG. 1A is a simplified three-dimensional view of a part of a conventional material-testing machine illustrating a motion and position of a test sample supported by a test sample table relative to a test probe, which during the test is maintained in contact with the surface of the test sample.

FIG. 1B is a top view of the surface of a test sample table of a material tester with surface defects on the sample table surface such as some areas (hatched areas), which are elevated over non-hatched area (white areas).

FIG. 1C is a graph that shows results of measurements obtained with the use of a contact-type height gauge and/or proximity sensor when the surface of test sample has raised portions of the type shown in FIG. 1B.

FIG. 1D shows a graph similar to FIG. 1C with wavy curves that may be interpreted as cyclic variations of the height on the surface of the test sample table in a contact point with the probe, where depending on a specific case each wave may be considered as a single defect detected on the surface during one revolution, or several waves may represent several defects detected during one revolution on the test sample surface.

FIG. 1E is a simplified view of an apparatus of the present invention, which is provided with a levelling stage sandwiched between the test sample stage and the test sample table.

FIG. 1F is a graph similar to those shown in FIGS. 1C and 1D obtained by measuring the surface of the test sample table after eliminating or reducing surface defects of the aforementioned surface with the use of the leveling mechanism of the present invention.

FIG. 1G is a schematic view illustrating possible deviation of the surface of the sample table from a reference plane that passes through the point of contact perpendicular to the probe axis.

FIG. 2 is a three-dimensional exploded view of the apparatus of the invention.

FIG. 3 is a three-dimensional top view of the apparatus in an assembled state.

FIG. 4 is a three-dimensional bottom view of the apparatus in an assembled form.

### DETAILED DESCRIPTION OF THE INVENTION

The present invention relates to a method and apparatus for maintaining constancy of force in contact between a test probe and test object, which are in a state of relative motion. More specifically, the invention relates to the field of material testing, e.g., to a method and apparatus for scratch testing, friction testing, resistance-to-wear testing, adhesion of a coating to a substrate, or to a similar testing procedure and apparatus in which during the test a test probe and test object are maintained in a state of relative motion, wherein either a test sample moves relative to a stationary probe in contact with the latter, or vice versa, the test sample is stationary and a probe moves relative to the sample.

The aforementioned tests are normally performed on a universal material tester, which typically contains a base that supports a stage having a drive for moving thereof in two mutually perpendicular directions, for rotating in a horizontal plane, and for moving in a vertical direction relative to a probe rigidly secured to a frame of the tester. An example of such a material tester is disclosed in U.S. Pat. No. 10,024,776 issued on Jul. 17, 2018 to Vishal Khosla, et al.

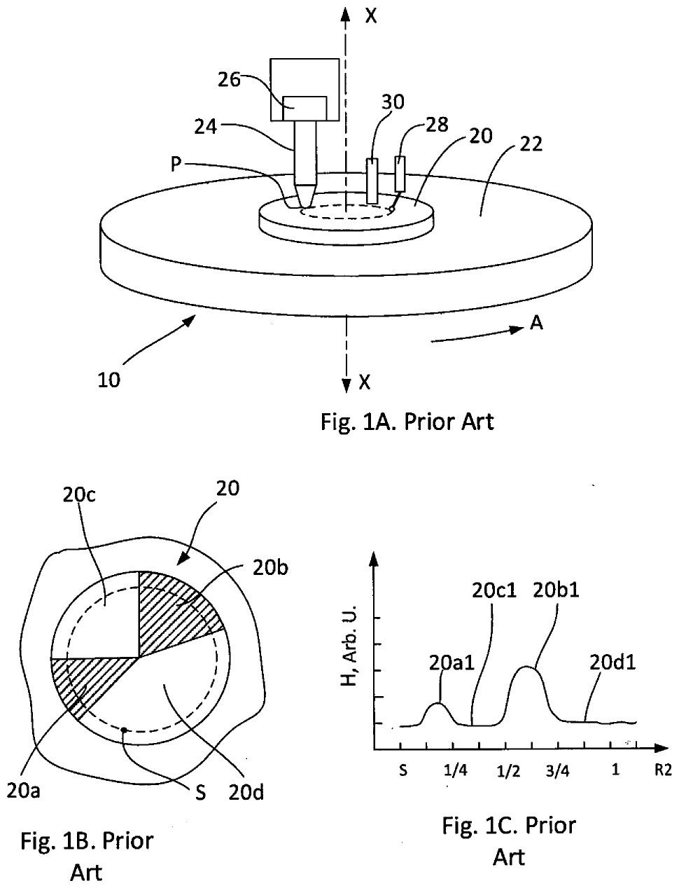

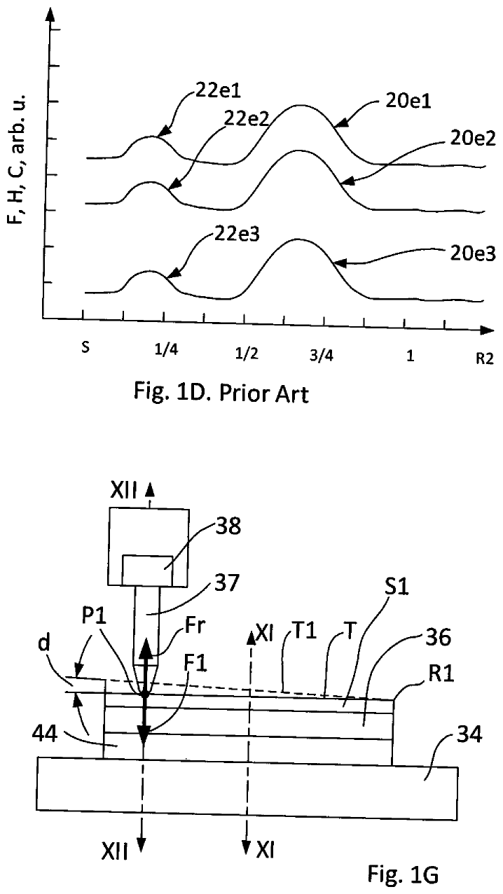

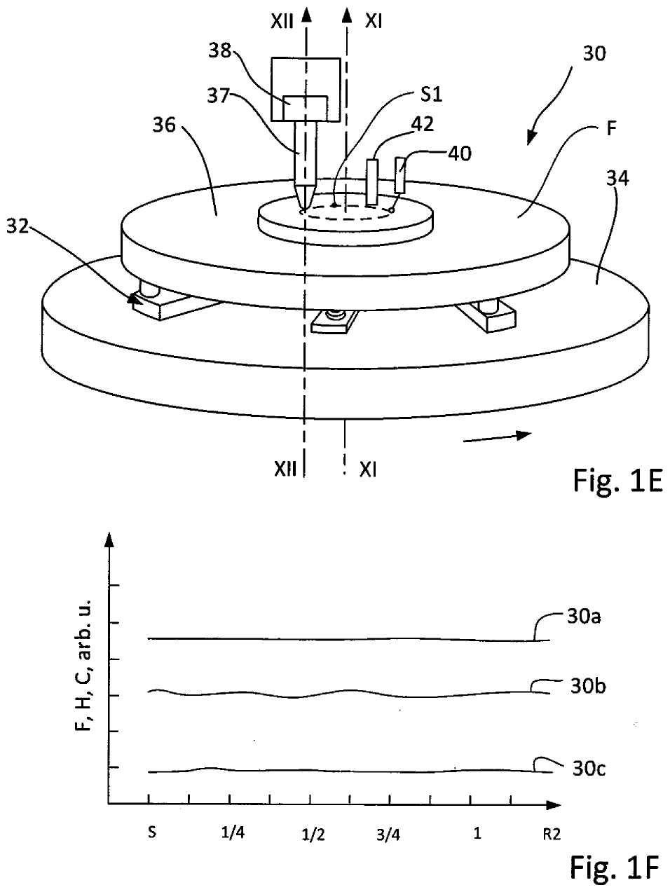

FIG. 1A is a simplified three-dimensional view of a part of a conventional material testing machine 10 illustrating a motion and position of a test sample 20 supported by a test sample table 22 relative to a test probe 24, which during the test is maintained in contact with the surface of the test sample 20. The probe is provided with a force sensor 26 that measures a pressure force at which the probe is pressed against the surface of the test sample in a point of contact. Arrow A shows direction of rotation of the test sample table, which supports a test sample 20 by a drive (not shown).

Reference numeral 28 designates a contact-type height gauge that measures height deviations of the test sample surface in the contact point during rotations. In other words, the height gauge detects deviations of the sample surface from a virtual reference plane R1 (FIG. 1G, which is explained later) that passes through the contact point P and arranged perpendicular to a longitudinal axis XII-XII of the test probe 24. It is assumed that the surface of the sample 20 itself has flatness close to ideal or within the allowable limits. In that case, deviations of the sample from parallelism to the aforementioned virtual reference plane will be caused by the defects on the surface of the test sample table 22 that supports the sample 20. Such defects, which can be defined as deviations from flatness, may be comprised of warp, waviness, raised portions on the surface, or the like. If necessary, the tester may be additionally provided with a proximity sensor 30, e.g., of a capacitive type, which will measure deviations of the sample plane from parallelism to the aforementioned virtual reference plane in terms of changes in the sensor capacity. It is understood that the aforementioned deviations will be reflected in the value of the contact force measured by the force sensor 26.

It should be noted, in this connection, that the coating technique has developed to an extent that the thickness of coatings on flat substrates may of the order of nanometers. Therefore, the requirements to devices for measuring the properties of coatings, in particular, for their resistance to scratching and wear, have become more stringent, especially with respect to the accuracy of measurements. This is because even a slightest deviation of the sample table surface (that during a test supports a thin flat object the coating of which is a subject of test) from flatness, or from parallelism to the motion plane (i.e., to a plane that passes through the contact tip of the probe perpendicularly to the probe axis XII-XII) will lead to inaccuracy of the test measurements (FIG. 1G, which is explained later).

FIG. 1B is a top view of the test sample table 22 in the area that supports a thin circular sample 20 plated with a nanometric coating (not shown). Assume that the hatched areas 20a and 20b of the sample table surface are elevated over non-hatched areas 20c and 20d. In that case, the results of measurements obtained with the use of the contact-type height gauge 28 and/or proximity sensor 30 will be represented by the graph shown in FIG. 1C, where the abscissa axis X shows a number of revolutions or parts of revolutions, i.e., the path of the probe 24 in the relative motion over the test sample table, and the ordinate axis Y shows a contact force or deviation of the sample table surface F from the aforementioned reference plane R1 (See FIG. 1G, which is a schematic view illustrating possible deviation d of the surface of the sample table from a reference plane R1 that passes through the point of contact P1 perpendicular to the probe axis XII-XII). In FIG. 1G, the force measured by the force sensor 38 is designated by reference F1; F_{R} is a reaction force. In FIGS. 1 and 1C, letter S designates a starting point of rotation. R2ₒₙ abscissa axis of FIG. 1C designate revolutions.

In the graph of FIG. 1C, the wavy portions 20a1 and 20b1 correspond to the raised portions 29a and 20b, and the flat portions 20c1 and 20d1 correspond to the areas 20c and 20d, which are free of defects.

Referring back to FIG. 1A, let us consider the graphs shown in FIG. 1D with the same coordinate axes as those in FIG. 1C. Waves 20e1, 20e2, and 20e3 of respective curves 22e1, 22e2, and 22e3 may be interpreted as cyclic variations of the height of the surface of the test sample table in a contact point P with the probe 24 caused by deviations of the aforementioned plane R1 (FIG. 1G) from parallelism to the reference plane which is perpendicular to the longitudinal axis XII-XII of the test probe 24. Depending on a specific case, each wave may be considered as a single defect detected on a disk during one revolution, or several waves may represent several defects detected during one revolution on the surface of a single disk.

FIG. 1E is a simplified view of an apparatus 30 of the present invention, which is provided with a levelling stage 32 sandwiched between the test sample stage 34 and the test sample table 36. The levelling stage 32 has a below-described adjustable leveling mechanism for eliminating deviations of the sample-supporting surface from flatness and parallelism to a plane R1 perpendicular to the longitudinal axis XII-XII of the probe 37 (FIG. 1G). The longitudinal axis XII-XII of the probe 37 is parallel to an axis XI-XI of rotation of the test sample table 36.

Similar to the apparatus 20 of FIG. 1, the apparatus of FIG. 1E of the invention is equipped with a flatness deviation measurement device 40 for measuring deviation of the surface of the sample S1 from the parallelism to the plane perpendicular to the longitudinal axis XII-XII of the probe. The device 40 may be represented by a contact-type height gauge and/or a capacitive proximity sensor 42.

It can be seen from the graphs of FIG. 1F that, by using the apparatus 30 of the present invention, the deviation curves 30a, 30b, and 30c are straightened which testifies to the fact that the aforementioned deviations are either eliminated or significantly reduced and that the contact force F1 remains constant (FIG. 1G).

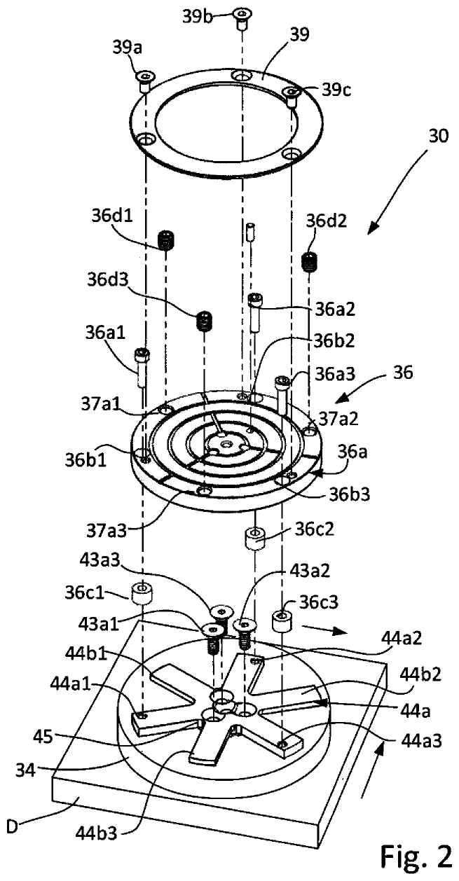

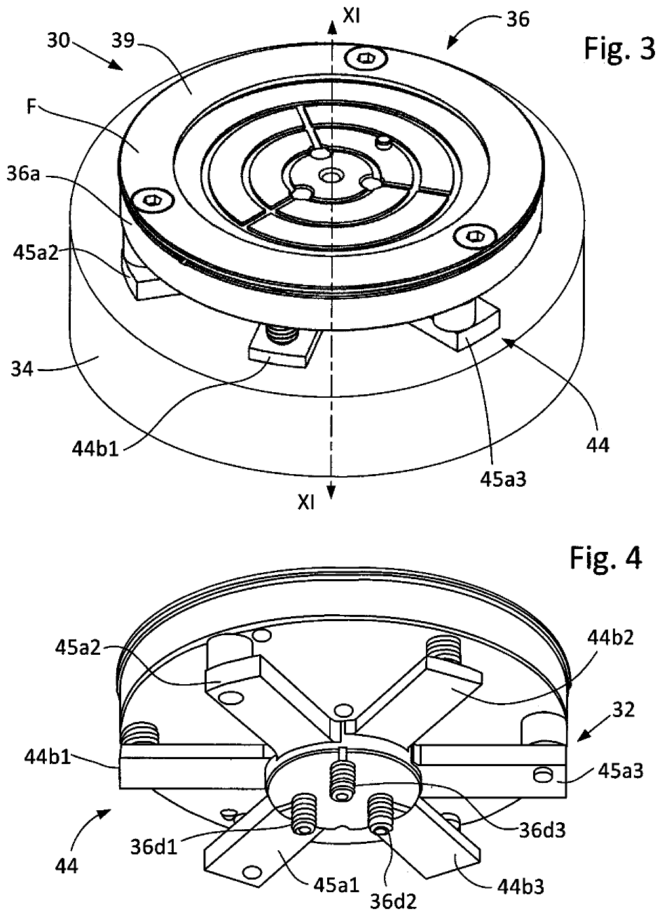

Having considered the principle of the present invention, let us refer now to practical embodiments exemplifying the apparatus and method of the invention. FIG. 2 is a three-dimensional exploded view of the apparatus 30 of the invention (hereinafter referred to merely as “the apparatus”) for maintaining constancy of the force F1 (FIG. 1G) in contact of the test probe with a test object, FIG. 3 is a three-dimensional top view of the apparatus 30 in an assembled form, and FIG. 4 is a three-dimensional bottom view of the apparatus 30 in an assembled form (in FIG. 4, the test stage is not shown).

As can be seen from the drawings, the apparatus 30 contains a sample stage 34 provided with at least a rotary motion drive (not shown) having a rotary axis XI-XI (FIG. 1E) and a test sample table 36 for supporting a test sample S1, e.g., a thin disk, having a flat test surface T. A drive mechanism D (FIG. 2) for the test stage 34 is beyond the scope of the present invention and may be exemplified by one shown in U.S. Pat. No. 10,024,776.

The levelling stage 32 is sandwiched between the test sample stage 34 and the test sample table 36 having a sample-supporting surface F (FIG. 1E and FIG. 3). The levelling stage 32 contains an adjustable leveling mechanism 44 (FIGS. 3 and 4) for eliminating deviations d of the sample supporting surface F from flatness and parallelism to a reference plane R1 perpendicular to the longitudinal axis XII-XII of the probe 37 (see FIG. 1G that illustrates possible deviation d of the sample supporting surface F shown by a broken line and designated in the deviated position by symbol T1).

As seen from FIG. 2, the levelling stage contains a carrier member 36a, and a levelling member 44a, which is a part of the leveling mechanism 44 and secured to the carrier member 36a in a spaced relationship to the latter. In the specific embodiment shown in FIG. 2, the levelling member 44a is secured to the carrier member 36a by screws 36a1, 36a2 and 36a3, which pass through holes 36b1, 36b2 and 36b3, through respective spacers 36c1, 36c2 and 36c3, and screwed into respective threaded holes 44a1, 44a2, and 44a3 formed in rigid radial arms 45a1, 45a2, and 45a3. The arms 45a1, 45a2, and 45a3 (FIG. 4) constitute parts of the rigid portion 45.

According to one or several aspects of the invention, the levelling member 44a has a rigid portion 45 (FIG. 4), springing elements 44b1, 44b2, and 44b3, which are connected to the rigid portion 45, and thrust elements 36d1, 36d2, and 36d3 that pass through the threaded holes 371, 37a2, and 37a3 of carrier member 36a and rest against the springing elements 44b1, 44b2, and 44b3. The trust elements are adjustable with regard to thrust applied to the springing elements 44b1, 44b2, and 44b3. Change of thrust forces applied by the thrust elements to the springing elements makes it possible to adjust a position of the sample supporting surface F relative to the virtual reference plane R1, which is perpendicular to the longitudinal axis XII-XII of the probe 37 (FIG. 1G), and thus to adjust the contact force F1 (FIG. 1G).

The rigid portion 45 is rigidly secured to the sample stage 34 by screws 43a1, 43a2, and 43a3, and the springing elements 44b1, 44b2, and 44b3 are made in the form of springing radial arms that project outward from the rigid portion 45.

In the illustrated embodiment, the apparatus 30 is provided with a flat protective ring 39 (FIG. 2), which is placed onto the test sample table 36 for masking the heads of the screws, etc. The ring 39 is attached to the carrier member 36a of the test sample member 36 by screws 39a, 39b, and 39c. The heads of these screws are placed in countersunk holes. The surface of the ring 39 is arranged in flush with or below the surface F of the sample table and does not participate in supporting the sample S1.

The invention also provides a method for maintaining constancy of a contact force F1 (FIG. 1G) in contact between a test probe 37 and the test object S1 having a test surface T, which during the test participate in a relative motion.

According to the method, prior to testing properties of the test object F, such as resistance to wear, resistance to scratching, etc., the test object S1 is moved (in the illustrated case, rotated) relative to the test probe 37, and during this motion, position of the surface F of the test sample table 36 is adjusted by using the adjustable leveling mechanism 44 so as to reduce deviations d of the test table surface F from flatness and parallelism to a reference plane R1 perpendicular to the longitudinal axis XII-XII of the probe 37 (FIG. 1G). The method is carried out on a material testing machine and is implemented in such procedures as scratch test, abrasive resistance test, measurement of tribology properties, or the like.

Adjustment is carried out by using the screws 36d1, 36d2, 36d3, which are in contact with the springing elements 44b1, 44b2, and 44b3 and which, by acting on springing elements, change an inclination position of the test sample table 36, and hence of the test object S1, relative to the reference plane R1 perpendicular to the test probe 37.

Upon completion of the adjustment, a test object is placed onto the surface F of the test sample table 36, and the apparatus 30 is ready for precision measurement of sample material properties, such as, e.g., wear resistance properties or scratch resistant properties of a coating layer (not shown) applied onto the surface of a substrate and having a thickness in a nanometers range.

Although this specific disclosure relates to a case of a rotary motion performed by a test sample relative to a stationary probe, it is understood that the invention is not limited by the illustrated embodiments and that these embodiments and related descriptions are considered only as examples. A situation where a test sample performs linear motion relative to a stationary test probe or a probe performs reciprocating motions relative to a stationary sample is a subject of another patent application filed by the same inventors. Furthermore, although the invention is described with reference to testing a thin coating on the surface of a circular substrate such as, e.g., a semiconductor disk, the principle of the invention is applicable to testing surfaces of monolithic material samples. The number of radial springing elements shown in the drawings may be less than three or more than three. This number may be even or odd. Any other changes or modifications are possible provided that these changes and modification do not depart from the scope of the attached patent claims.

1. An apparatus for maintaining constancy of a force in contact between a test probe and a test object, which are in a state of a relative motion, the apparatus comprising:
a test sample stage provided with at least a rotary motion drive having a rotary axis;
a test sample table for supporting a test sample, which has a flat test surface;
a test probe, which has a longitudinal axis parallel to the rotary axis and which during a test is maintained in contact with the flattest surface, wherein the flat test surface of the test sample supported by the test sample table and the test probe are maintained in a relative motion; and
a levelling stage sandwiched between the test sample stage and the test sample table having a sample-supporting surface, the levelling stage having a leveling mechanism with a levelling member for eliminating deviations of the sample-supporting surface from flatness and parallelism to a virtual reference plane that is perpendicular to the longitudinal axis of the test probe and passes through a point of contact of the test probe with the sample-supporting surface.

2. The apparatus according to claim 1, wherein the levelling member comprises a rigid portion, springing elements connected to the rigid portion, and thrust elements that pass through the carrier member and rest against the springing elements for adjusting thrust forces applied by the thrust elements to the springing elements for adjust a position of the sample supporting surface relative to the virtual reference plane.

3. The apparatus of claim 2, wherein in the aforementioned relative motion the test probe is stationary and the test sample stage participates in a rotary motion.

4. The apparatus of claim 3, wherein the rigid portion is rigidly secured to the test sample stage, and the springing elements comprise springing radial arms projecting outward from the rigid portion.

5. The apparatus of claim 4, wherein the adjustable thrust elements are screws that are screwed through the carrier member to contact with the springing radial arms.

6. The apparatus of claim 5, wherein the rigid portion of the levelling member has threaded holes and the apparatus is further comprises: a carrier member, which is placed onto the levelling member; spacers; and attachment screws that are threaded into the threaded holes of the rigid portion through the carrier member and the spacers for providing said spaced relationship.

7. The apparatus of claim 1, further comprising a force sensor for measuring a force that occurs during testing in a point of contact of the probe with the flat test surface.

8. The apparatus of claim 7, wherein in the aforementioned relative motion the test probe is stationary and the test sample stage participates in a rotary motion.

9. The apparatus of claim 8, wherein the leveling mechanism for eliminating deviations of the sample supporting surface from flatness and parallelism to a plane perpendicular to the longitudinal axis of the probe comprises at least a flatness deviation measurement device for measuring deviation of the flat test surface from the parallelism to the reference plane.

10. The apparatus of claim 9, wherein the levelling member comprises a rigid portion, which is rigidly secured to the test sample stage and wherein the springing elements comprise springing radial arms projecting outward from the rigid portion.

11. The apparatus of claim 10, wherein the adjustable thrust elements are screws that are screwed through the levelling member to contact with the springing radial arms.

12. The apparatus of claim 11, wherein the rigid portion of the levelling member has threaded holes and the apparatus is further comprises: a carrier member, which is placed onto the levelling member; spacers; and attachment screws that are threaded into the threaded holes of the rigid portion through the carrier member and the spacers for providing said spaced relationship.

13. The apparatus of claim 12, wherein the flatness deviation measurement device comprises a contact height gauge for measuring deviations of the flat test surface from the plane perpendicular to the longitudinal axis of the probe during the test when the test probe is maintained in contact with the flat test surface.

14. The apparatus of claim 12, wherein the flatness deviation measurement device is provided with a capacitive proximity sensor arranged above the flat test surface for measuring deviations of a distance from the flat test surface.

15. The apparatus of claim 13, wherein the flatness deviation measurement device is further provided with a capacitive proximity sensor arranged above the flat test surface for measuring deviations of a distance from the flat test surface.

16. A method for maintaining constancy of a contact force in contact between a test probe and a test sample table having a sample supporting surface, which are in a state of a relative motion performed in a material testing machine, the method comprising:
prior to a test, moving the test probe to contact with the sample supporting surface of a test sample table and measuring a contact force during the relative motion;
providing an adjustable leveling mechanism for eliminating deviations of the test surface from flatness and parallelism to a reference plane that passes through a point of contact of the test probe with the sample supporting surface perpendicular to the test probe; and
adjusting positions of the sample supporting surface during the relative motion prior to testing the test object.

17. The method of claim 16, wherein the test probe is a probe of a material testing machine, the method further comprising the steps of:
providing the material-testing machine with: a test object stage having a drive mechanism for providing said relative motion, the test object stage supporting the test sample table, which supports a test sample; and a levelling stage sandwiched between the test object stage and the test sample table, the levelling stage comprising an adjustable leveling mechanism for carrying out said step of adjusting positions of the sample support surface.

18. The method of claim 17, comprising a step of providing the adjustable leveling mechanism with springing elements which are in contact with adjustable thrust elements installed in the test sample table and which thus change an inclination position of the test sample table, and hence of the test object, relative to the reference plane.
